(19) United States
(12) Patent Application Publication
(10) Pub. No.: US 2026/0008507 A1
(43) Pub. Date: Jan. 8, 2026

(54) Low friction kingpin docking interface for tractor-trailer transport vehicles and method thereof

(71) Applicant: John Walker, Saint-Lambert, QC (CA)

(72) Inventor: John Walker, Saint-Lambert, QC (CA)

(21) Appl. No.: 19/258,322

(22) Filed: Jul. 2, 2025

Related U.S. Application Data
(60) Provisional application No. 63/667,096, filed on Jul. 2, 2024.

(51) Int. Cl. B62D 53/08

(52) U.S. Cl. CPC B62D 53/085; B62D 53/0885

(57) ABSTRACT

A mechanism attached to the trailer of a semi tractor trailer that uses a low friction UHMW or similar bearing sheet material as an interface between the two components. This wear item is easily replicable without the use of fasteners such as screws nuts or bolts. The invention uses a plug and play bayonetted snap in methodology and is easily installed on new or existing rigs such as 18/26-wheeler highway transports. The wearable bearing can be replaced by novice operators not skilled in technical installations in only a few minutes and at very low cost.

### CROSS-REFERENCE TO RELATED APPLICATIONS

The present patent application claims the benefits of priority of U.S. Provisional Patent Application No. 63/667,096, entitled “LOW FRICTION KINGPIN DOCKING INTERFACE FOR TRACTOR-TRAILER TRANSPORT VEHICLES” and filed at the United States Patent and Trademark Office on Jul. 2, 2024, the content of which is incorporated herein by reference.

### FIELD OF THE INVENTION

The present invention generally relates to devices and methods for reducing rotational friction between a semi-tractor and an attached trailer towed behind a big rig such as but not limited to an 18-wheeler.

### BACKGROUND OF THE INVENTION

Reducing rotational friction between a semi-tractor and an attached trailer towed behind a big rig has been an issue for many years. Known methods comprise adding a layer of grease between the rig of the tractor and the attachment portion of the trailer. Such methods are not environmentally friendly and require a high level of maintenance. Furthermore, grease is prone to increasing or thickening viscosity in cold climates, thus increasing the risk of partial seizure or stiction when the semi-tractor is turning or changing lanes on highways.

Common 18-wheel tractors use a fifth wheel to grab and hold a kingpin attached to a trailer which could be a box type, flat-bed, tanker or numerous other type trailers all of which grab this kingpin to pull the load. Typically, such kingpin has a flat 18″ radius surface around it that permits a swiveling action as the two components of the rig navigate our roads. This swiveling action contact area is typically steel to steel with a requirement for heavy grease to reduce friction between both surfaces. A tractor may require many gallons of grease per year and a maintenance of application of grease frequently. The grease unfortunately ultimately ends up on roads and highways.

Moreover, when operators neglect the maintenance procedure to apply grease on steel surfaces, both steel surfaces suffer from premature wear and tear issues requiring expensive replacement. Numerous attempts have been developed to mitigate this problem such as adding a roller type bearing or bushing to the kingpin to reduce friction. Unfortunately, this design appears to suffer from premature failure due to the huge loads including inertial loads applied to this kingpin interface. Several inventions have been developed that use a thin sheet of plastic such as Teflon to act as an alternative design concept to lower this friction as a replacement for grease. The plastic shall be very thin, typically ¼″ and needs to be attached securely to the trailer's kingpin plate to prevent damage or failure of the plastic. Plastic any thicker is generally outside the limits of conventional kingpin trailer vertical docking tolerances. This is particularly relevant during the actual docking and undocking phase when mating both components together. The weight on the trailer kingpin can be a significant percentage of the 80,000 lb. limit of rig, such as but not limited to 50% of the weight. The high proportion of weight on the kingpin combined with the fact that drivers will often hit the trailer hard and fast because of vertical mismatch between tractor fifth wheel and trailer may increase wear and tear of the steel surfaces.

Some designs use thin plastic sheet screwed to the surface using many screw fasteners to maintain the said plastic sheet in place. The screws, which are typically button head cap screws or hex screws end up becoming filled with sand, dirt and grease hiding them from maintenance crews which also increase the time it takes to remove them before replacing the worn-out plastic bearing. Also, since the plastic sheet is very thin there is not much mechanical thickness to hide and support this plastic by attaching it to the kingpin plate, especially within the closed radius zone of the kingpin, such as 18″ radius zone. When the screws are clogged, the time to remove the said screws is increased when replacing the worn-out plastic bearing. Moreover, as the plastic wears out, the plastic compresses with load forces causing the fifth wheel steel to approach the top surface of these screw heads again within the rotation zone. The exposed screw heads can come in contact with the fifth wheel and may damage the surface requiring early and often replacement of this plastic sheet when there is still some bearing life left. This has resulted in operators moving away from continuing to use this technology even though they find it useful.

There is thus a need for an improve device to reduce rotational friction between a semi-tractor and an attached trailer towed behind a big rig.

### SUMMARY OF THE INVENTION

The shortcomings of the prior art are generally mitigated by a low friction kingpin docking interface for tractor-trailer transport vehicles that allows to keep the diameter disk of plastic of the kingpin completely free from fasteners in a way that may be quickly and easily replaced. In some aspects of the invention, the diameter may be of 36 inches.

Some aspects of the invention help mitigate the above-mentioned issues by keeping a plastic member, such as but not limited to a 36″ diameter plastic disk, completely free from any fasteners and to allow fast and easy replacement.

The device of the present invention is generally configured to act as a mechanism to clamp/hold/restrain a low friction plastic bearing ideally using sheet of plastic such as ultra-high molecular weight (UHMW). The sheet of plastic is typically 18-inch radius disk/plate normally ¼″ thick which creates a low friction interface between both tractor and trailer. Understandably the thickness may vary based on the applications. The plastic sheet is prevented from moving in pitch/roll/or yaw and thus is locked in place by the metal mechanism described in this invention.

In another aspect of the invention, the use of a novel snap-in design methodology is provided. Mostly any rig operators, including operators being less mechanically inclined, may replace the wear docking interface at very low cost and in only a few minutes. Another important aspect of this invention is that the docking interface may replace heavy grease normally applied previously to both surfaces when not using the disclosed docking interface. This has huge potential environmentally since 100% of this grease ends up on our roadways. Another benefit is that the worn UHMW plastic is recyclable with very little physical lost material since UHMW has very long molecular chains which compress and shift position without shearing off typically.

In another aspect of the invention, the retention ring component is bolted to the steel plate instead of welding to hold the steel mechanism to the kingpin plate.

In another aspect of the invention, the outer support ring is already integrated into the fabrication of a new kingpin plate.

In yet another aspect of the invention, the retention ring is attached directly underneath standard box type carrier trailers (18-wheeler highway trailers) such as those without a removable kingpin plate. This device would likely be bolted in place allowing operators to easily revert back to their original configuration if so desired.

In a further aspect of the invention, the entire device is configured as a kit for DIY (do it yourself) installation.

In another aspect of the invention, a low friction kingpin docking interface for a tractor-trailer transport vehicle is provided. The low friction kingpin docking interface for a tractor-trailer transport vehicle comprises a low friction bearing structure shaped to surround a kingpin of a trailer reducing friction between a trailer and a docking system of a tractor and a retaining assembly attachable to an underside portion of a trailer for detachably mounting the low-friction bearing structure to the trailer.

The bearing structure may comprise a plurality of segments, each segment being lockable with the retaining assembly. The bearing structure may be mountable to the retaining assembly by being pivoted while each of the segments are locked to the retaining assembly. Each segment may comprise a resilient tab comprising a portion lockable with the retaining assembly.

The retaining assembly may comprise a plurality of locking members, each locking member lockingly receiving the lockable portion of the bearing structure. The locking members of the retaining assembly may be a recess on a bottom surface of the retaining assembly and the lockable portion of the bearing structure being a lip matching with the recess.

The bearing structure may be made of resilient plastic. The resilient plastic may comprise ultra-high molecular weight (UHMW) polyethylene. The bearing structure may be circular and the retaining assembly may be annular and shaped to enclose the periphery of the bearing structure. The bearing structure may comprise a central portion and flaps radially extending from the central portion. Each of the flaps of the bearing structure may be separated by a slot. The bearing structure may comprise apertures for receiving a tool adapted to pivot the bearing structure in relation to the retaining assembly and to simultaneously push or pull the flaps to or of the retaining assembly.

The retaining assembly may comprise a plurality of arc segments joined to form a continuous annular ring.

In yet another aspect of the invention, a low friction bearing structure is provided. This low friction bearing structure reduces friction of an attachment between a tractor and a trailer transport vehicle shaped to surround a kingpin of the trailer to reducing friction between a trailer and a docking system of a tractor. The low friction bearing structure is attachable yet detachable to a retaining assembly attached to an underside portion of a trailer, the bearing structure being made of rigid yet resilient material.

The bearing structure may comprise a plurality of segments, each segment comprising a resilient tab comprising a portion lockable to a retaining assembly. The bearing structure may be made of ultra-high molecular weight (UHMW) polyethylene. The bearing structure may be circular. The bearing structure may comprise a central portion and flaps radially extending from the central portion.

In yet another aspect of the invention, a method to remove a low-friction bearing plate from a retaining assembly is provided. This method comprises resiliently and simultaneously releasing segments of the bearing plate to release the same from the retaining assembly and pivoting the bearing plate to release and unlock the bearing plate.

The method may be used to extend the life of a bearing plate. The method may further comprise locking the bearing plate to the retaining assembly once pivoted, to evenly wear the bearing plate. The method may further comprise using a tool to unlock and pivot the segments of the bearing plate.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a bottom plan view of an embodiment of a low friction kingpin docking interface shown mounted on an exemplary box trailer according to the principles of the present invention.

FIG. 2 is a top plan view of the low friction kingpin docking interface of FIG. 1.

FIG. 3 is a perspective view of the low friction kingpin docking interface of FIG. 1.

FIG. 4 is a perspective view of the low friction kingpin interface of FIG. 1 shown mounted around a kingpin.

FIG. 5 is a perspective view of an embodiment of a retention ring shown without the bearing.

FIG. 6 is a perspective view of an embodiment of a retention ring shown with one segment removed.

FIG. 7 is a top plan view of an embodiment of a bearing in accordance with the principles of the present invention.

FIG. 8 is a top plan view of an embodiment of the bearing of FIG. 7.

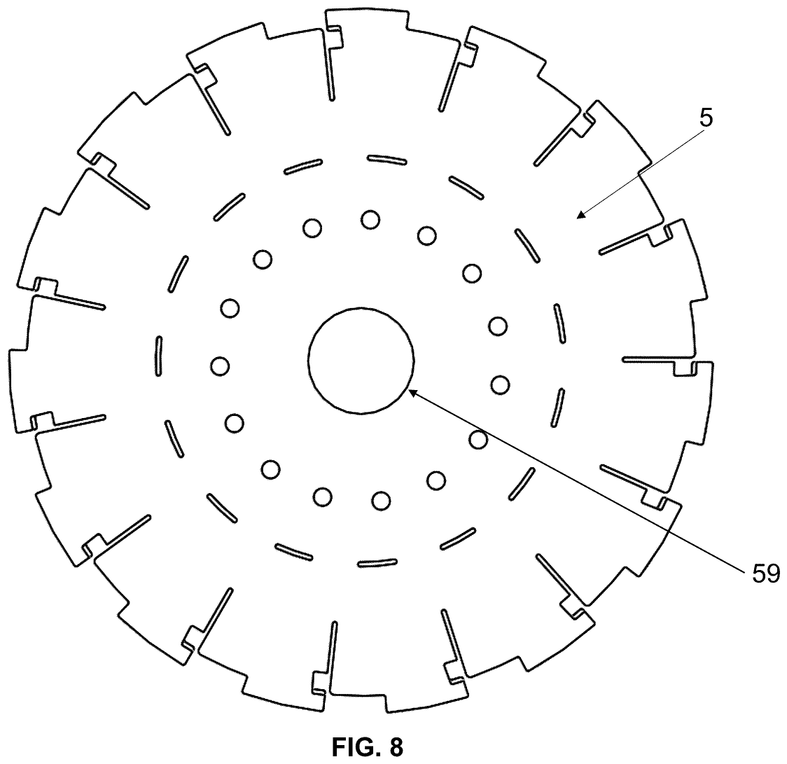

FIG. 9 is a perspective view of an embodiment of bearing shown twisted prior to insertion within a retention ring.

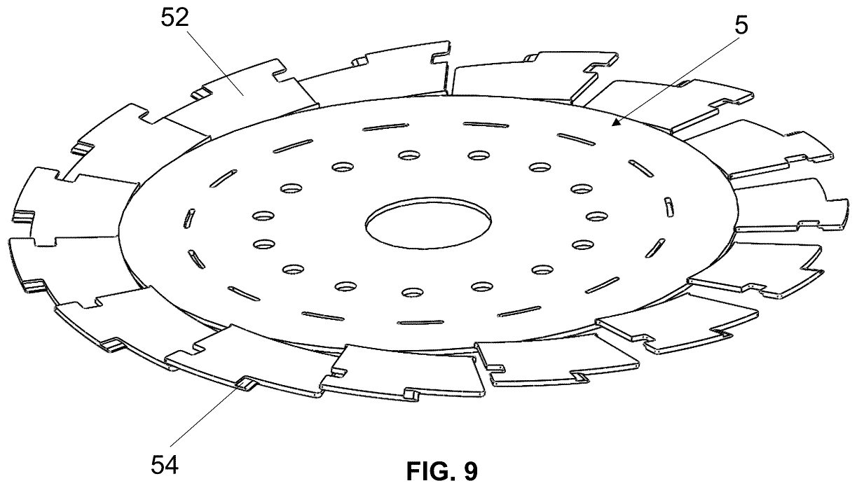

FIG. 10 is a perspective view of a bearing showing within a retention ring, the bearing being shown with tabs being partially twisted for installation or removal.

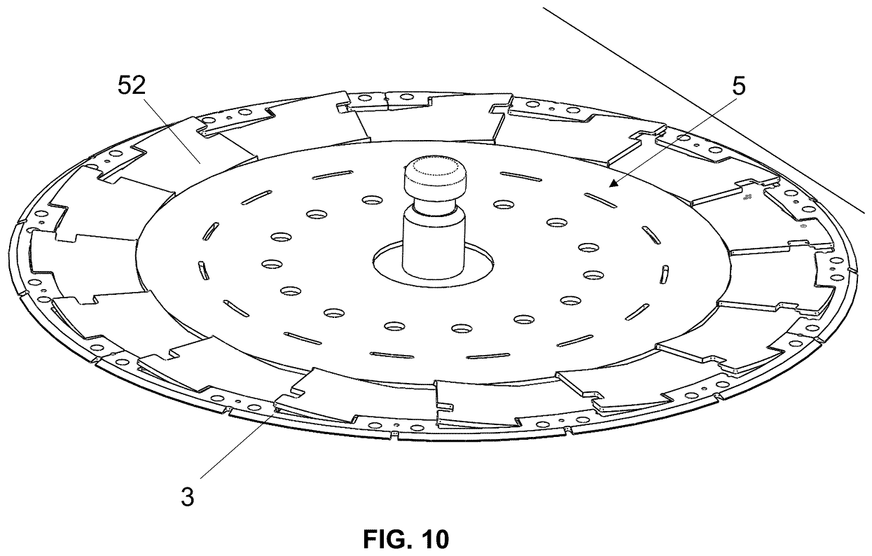

FIG. 11 is a perspective view of another embodiment of a kingpin interface having multiple retention zones according to the principles of the present invention.

FIG. 12 is an exploded perspective view of the kingpin interface of FIG. 11.

FIG. 13 is top exploded perspective view of the kingpin interface of FIG. 11.

FIG. 14 is a perspective view of a tanker support plate of the kingpin interface of FIG. 11 shown without the bearing.

FIG. 15 is a perspective view of an embodiment of the bearing of the kingpin interface of FIG. 11 showing front and side retention zones.

FIG. 16 is a close-up perspective view of the front and side retention zones of the bearing shown at FIG. 15.

FIG. 17 is an exploded perspective view of another embodiment of a kingpin interface according to the principles of the present invention.

FIG. 18 is a perspective view of the kingpin interface of FIG. 17 shown with the arms in an open position.

FIG. 19 is a perspective view of the kingpin interface of FIG. 17 shown with the arms in a locked position.

### DETAILED DESCRIPTION OF THE INVENTION

A novel low friction kingpin docking interface for tractor-trailer transport vehicles will be described hereinafter. Although the invention is described in terms of specific illustrative embodiments, it is to be understood that the embodiments described herein are by way of example only and that the scope of the invention is not intended to be limited thereby.

Usual tractor trailer rigs operate in all weather conditions over four seasons worldwide. These factors often involve unique conditions between the two main points of rig control namely the combination, truck/trailer rotation zone and conversely the front tires. The rotational kingpin friction and more specifically stiction attempting to lock the tractor trailer together. The second point of control is between the front tires and road surface which is constantly changing its frictional characteristics moment by moment. As mentioned, this is especially prevalent in subzero weather with the interface grease viscosity lowering and the friction between the two front tires and the road being the only control point of the entire rig assembly. It is also prevalent in wet roads or those covered in debris such as loose fallen sand or dead wet leaves in the fall on the road surface.

With huge loads pressing the tractor and trailer together, there is often contact loads exceeding 20 MT between the tractor and the trailer. Only the friction between the road and the front tires can break this monolithic connection. Moreover, there are 700 plus square inches of contact between tractor and trailer with only 150 square inches of contact between the front tires and road surface. Only 150 square inches attempting to maneuver 80,000 lbs. and the other 16 or even 24 wheels fixed and locked parallel to the rig. In this scenario a unique situation can occur where a driver has been in the slow lane for many consecutive miles specifically prevalent in cold winter conditions. The driver then decides to pass a slower vehicle moving into the fast lane. Since winter driving cold temperatures often involve intermittent blowing snow across the highway the actual moment by moment road conditions can vary drastically almost metre by metre. If the driver inputs a lane change using his steering wheel while passing a section of road with blowing snow on it and the rig can become locked together. This will cause the rig to continue straight without deviating even with this driver steering input. Then, a few metres later the rig comes past the open field to a section of the road where the snow is no longer blowing. At this point the rig can suddenly grab the road surface and the tires win aggressively breaking the monolithic bond with a sudden unexpected snap. This can-and-does lead to a loss of control even leading to a jackknifing scenario endangering the driver and other vehicles on the road. This situation is prevalent even with trucking companies from the South since they are often delivering farming goods to Northern cities such as New York, Boston Chicago or Monreal/Toronto. As well often these drivers are not as experienced in dealing with these cold weather driving conditions exacerbating the situation.

Given the same scenario with the current present invention this risk is greatly reduced since even on this blowing snow section of the highway the rig will begin to change lanes as commanded by the driver helping to avoid this sudden snapping from occurring in the first place effectively the front tires even with low friction authority are able to steer the rig into the adjacent lane.

It must also be noted that the angle of attack with respect to the road is always closer to zero with the present invention due to this lower friction, which helps save tire wear and tear and associated replacement cost and rubber debris pollution from worn out tires left on our highways. As mentioned, the grease usage is also not trivial since many operators apply a considerable amount per trailer per year. With over 15.5 million trucks on our roads in America representing 5% of all vehicles driving our highways. There is also the consideration of the fact that insurance companies rate trucking companies on two main variables: accidents per million kilometers and fatalities per 100 million kilometres. Companies are compared to each other using this matrix so these companies are often looking for ways to lower this ratio. This is the reason we often see a sign on the back of big rigs saying “how's my driving? Call 1-800-XXX-XXX” with rig number C1234567 identifier. Companies want to be the safest and the current embodiment of this invention will help to this end.

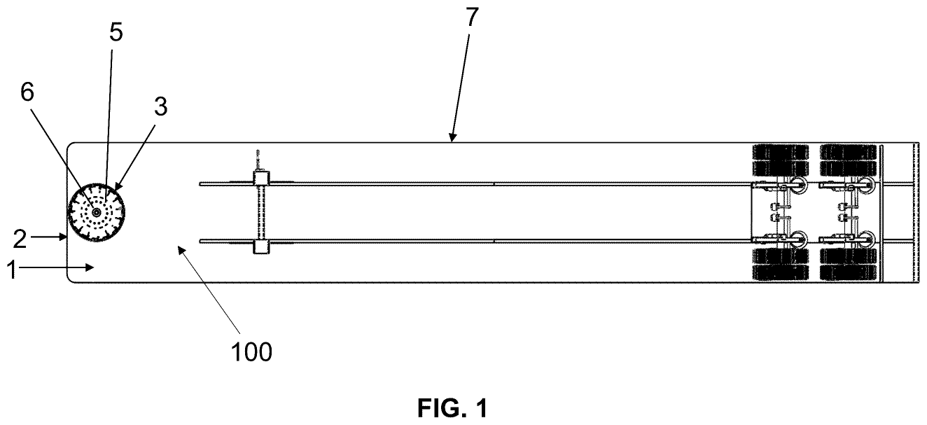

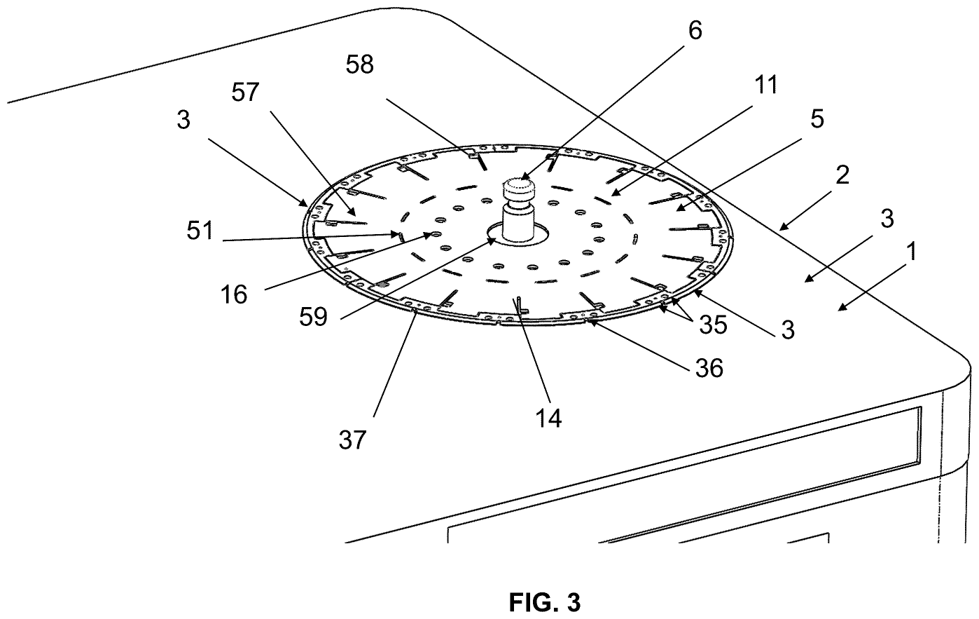

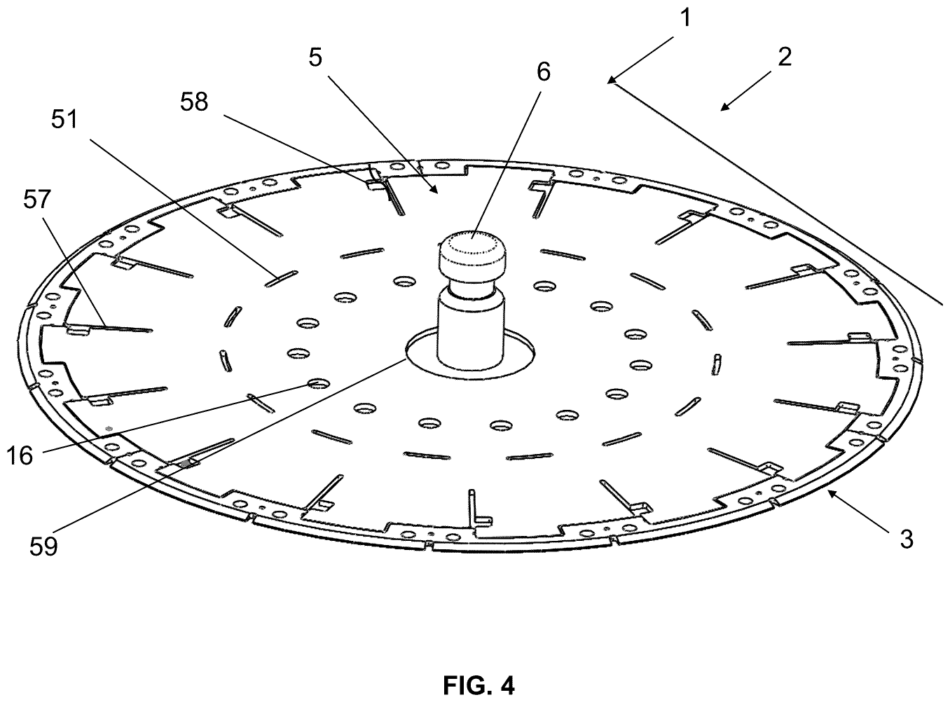

Referring to FIGS. 1-7, an embodiment of a low friction kingpin docking interface 100 for tractor-trailer transport vehicles is illustrated. Referring now to FIGS. 1-4, a box-type trailer 7 is shown with an embodiment of a low-friction kingpin docking interface 100 mounted thereof. In such embodiment, the low-friction kingpin docking interface 100 comprises a retainer assembly 3 and a main low friction surface 5 mounted around the kingpin 6 of the trailer. As illustrated, the trailer generally comprises a skid plate or surface 1 and a tractor trailer docking ramp 2. The main low friction surface 5 is detachably mounted to the retaining assembly 3 to ease installation and replacement of the low friction surface 5. The low friction surface 5 is typically made of low friction yet durable material, such as but not limited to UHMW. In use, the low friction surface 5 acts a friction reducing device between the skid plate 1 of the trailer and the tractor trailer docking ramp 2.

Such embodiment, is typically used on standard box trailers, which are the most common trailer type in North American. The low friction kingpin docking interface 100 leverages the natural spring or resilient characteristics of low friction surface 5 to ensure stable contact while allowing flexibility under load. The retaining assembly 3 is mounted to the front underside portion of the trailer. In some embodiments, the retaining assembly 4 may be bolted or welded in place.

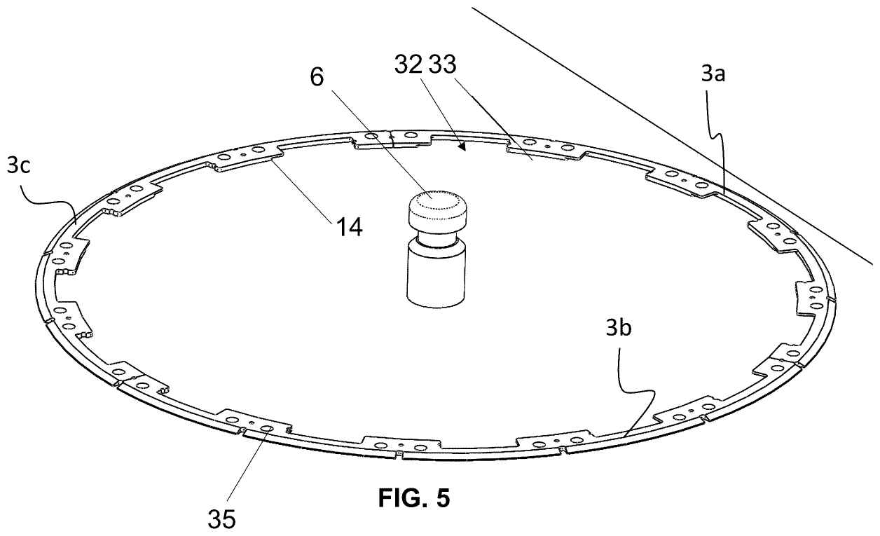

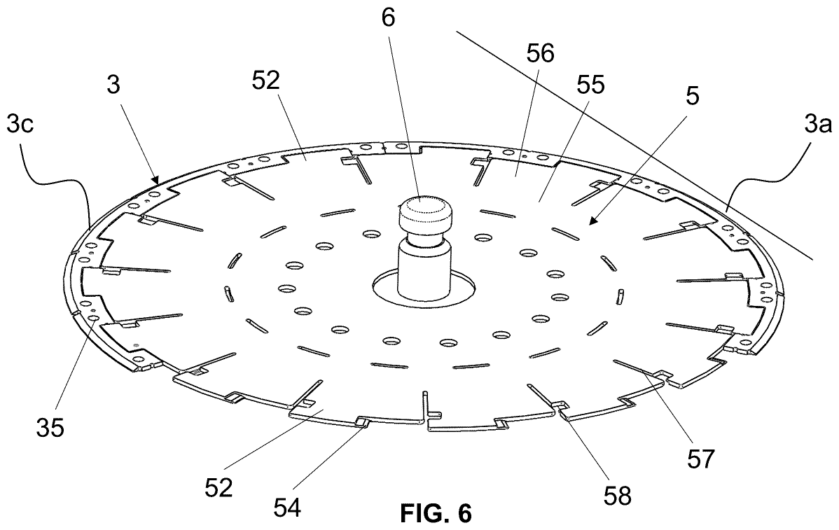

Referring to FIGS. 5 and 6, an embodiment of a retaining assembly 3 is shown. The retaining assembly 3 may comprise a plurality of segments 3a, 3b and 3c. In the illustrated embodiment, the retaining assembly 3 comprises three equal ring segments 3a, 3b, and 3c. Each segment 3a, 3b and 3c extending by 120 degrees and forming a complete circular enclosure for the low-friction surface 5. The retaining assembly 3 is adapted to enclose and retain the low-friction surface 5. In the illustrated embodiment, the low-friction surface 5 is resiliently held by the retaining assembly 3. The retaining assembly 3 and/or the segments 3a, 3b and 3c are typically made of rigid material, such as but not limited to metal.

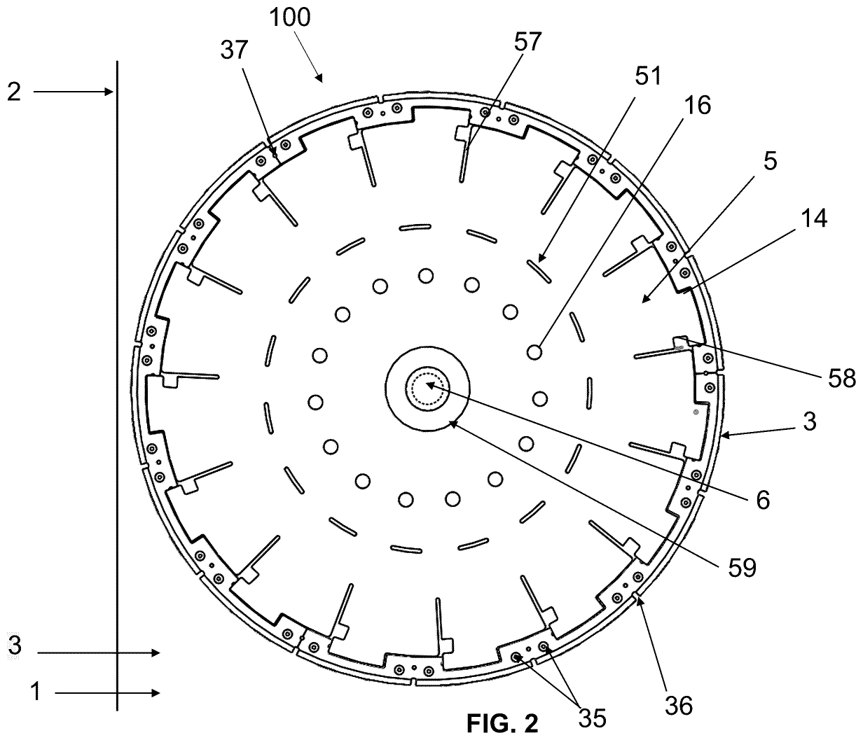

Sill referring to FIGS. 2, 5 and 6, the retaining assembly 3 comprises a plurality of recess portions 32 each adapted to receive matching protuberances 52 of the low-friction bearing 5. The recess portions 32 may alternate with protuberance or extensions 33 of the retaining assembly 3. The retaining assembly 3, and in this embodiment, the protuberance 33, may further comprise a snapping recess 14 adapted to receive and resiliently retain a matching tab 54 of the low-friction surface 5. In some embodiments, the snapping recesses 14 may be arranged at 24-degree intervals, resulting in 15 rotational indexing positions. Understandably, any number of snapping recesses 14 may be used within the scope of the present invention. The snapping recesses 14 generally allow the bearing plate 5 to be rotated (indexed) around the kingpin 6 when wear becomes localized, enabling redistribution of wear zones and extending the life of the part. The ring geometry also aims at ensuring that the low-friction bearing plate 5 remains locked in all translational and rotational degrees of freedom (i.e. pitch, yaw, roll).

The retaining assembly 3 may further comprise segment attachment points 36. In the illustrated embodiment, the segment attachment points 36 are weld tabs.

The locking interface system 100 may further comprise a counterclockwise locking mechanism using the trap points 14 for receiving the extensions 54 of the bearing. Such configuration generally aims at enhancing resistance to dislodgment during sudden stops or turns. The trap points 14 are typically positioned or integrated on a leading edge of the protuberance 33, thus ensuring positive retention of the bearing without relying on exposed mechanical fasteners.

Referring to FIG. 6, one of the three arc segments of the ring 3 is shown removed, revealing the modular nature of the ring. Each segment 3a-3c may mate directly to the adjacent ones and to the bearing plate 5 via complementary engagement features such as tongue-and-groove or overlapping lips. As such, the bearing surface 5 may be removed by partially or fully disassembling the retaining assembly 3.

In the illustrated embodiment, the retaining assembly 3 comprises apertures 35 for receiving fasteners to mount the retaining assembly 3 to the skid plate 1 of the trailer 7. Understandably, any other known mechanism or method to rigidly mount the retaining assembly 3 to the trailer may be used within the scope of the present invention.

In yet other embodiments, the retaining assembly 3 may comprise apertures or passages 37 adapted provide rotational movement to the bearing 5. As such, a portion of a tool could be inserted in one or many of the aperture 37 to generate rotation movement to unlock the bearing 5 from the retaining assembly 3 or to lock the same to the retaining assembly 3.

In embodiments having a plurality of segments 3a, 3b and 3c, the segments 3a, 3b and 3c are mounted to the trailer to form a round enclosure. Understandably, the retaining assembly 3 may have any other shape allowing the bearing 5 to be resiliently held by the retaining assembly 3.

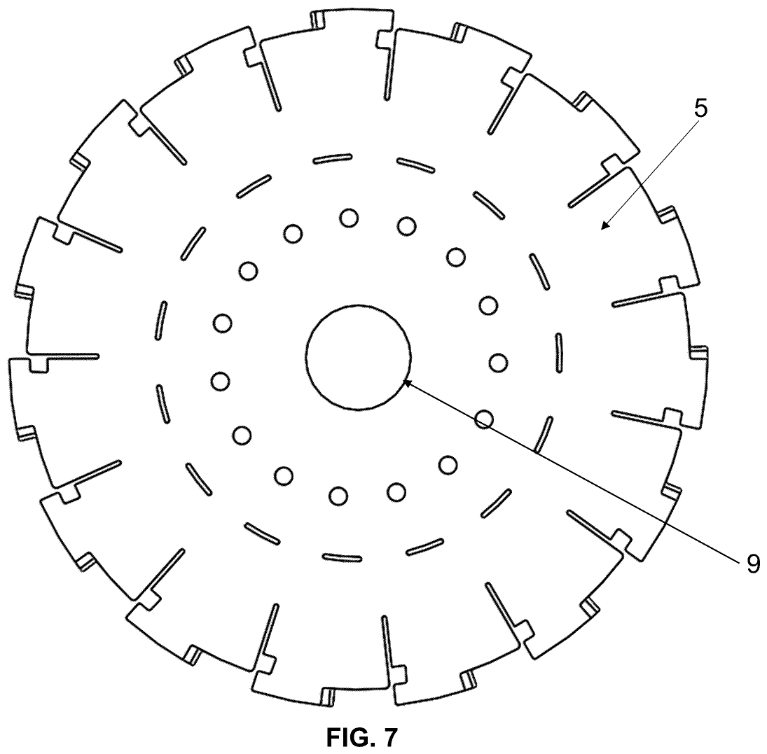

Referring now to FIG. 6, an embodiment of a low friction bearing surface 5 is illustrated. The low-friction bearing surface 5 comprises a central aperture 59 adapted to surround or at least partially surround the kingpin post 6. In some embodiments, the aperture 59 may be a 6-inch cutout. The ow-friction bearing surface 5 comprises a central portion 55 and flaps 56 resiliently extending from the central portion 55. In the illustrated embodiment, the bearing 5 further comprises slots or relief cuts 57 in between each flap 56. The slots 57 generally allow the flaps or tabs 56 to twist to allow the snap portion 54 to be inserted under the under the snapping recess 14 of the retaining assembly 3. In some embodiments, as shown at FIG. 7, the flaps 56 may be resiliently twistable from the central portion 55. The flaps 56 may further comprise the protuberance 52 matching the recess 32 of the retaining assembly 3. The flaps 56 may further comprise the snap portion 54 adapted to be resiliently inserted under the snapping recess 14 of the retaining assembly 3.

In yet other embodiment, the bearing 5 may comprise an insertion opening adapted to lift the flap 57 when removing the bearing 5 from the retaining assembly 3.

In further embodiments, the bearing 5 may comprise slots 51 adapted a tool to be inserted to rotate the bearing 5 when being installed, being removed or for rotating the bearing 5 to extend lifetime.

In such embodiment, the mounting of the bearing 5 to the retaining assembly 3 may be performed by first positioning a portion of the flap 56 over the protuberance 33 and another portion of the flap 56 within the recess 32. The second portion of the flap 56 is then pushed down and the bearing is pivoted to insert the snap portion 54 under the recess portion 14 of the retaining assembly 3. As such, the first portion of the flap 56 is also pivoted and positioned in the recess 32, as shown in FIG. 6. As such, the bearing 5 is easily mounted to retaining assembly 3.

To remove the bearing 5 from the retaining assembly 3, the first portion of the flap 56 is pulled and the bearing 5 is pivoted to move the second portion over the protuberance 33. As such, the bearing 5 is easily removed.

The bearing surface 5 may further comprise apertures 9. The aperture 9 may be used to insert a mounting and/or removal tool to pivot the bearing surface 5 about the kingpin 6. The apertures 9 may further act as drainage or mitigation holes to allow rain water, thawed ice or any other liquid or substance to evacuate and avoid pooling underneath the bearing surface 5, which is particularly advantageous for winter operation. The apertures 9 generally allow liquids to escape the interface between the trailer and tractor, reducing the risk of hydroplaning, freezing, or contamination buildup at the contact surface. The inclusion of drainage channels further supports the bearing's reliability in adverse weather conditions.

Referring now to FIG. 7, another embodiment of a bearing surface 5 is shown. In this embodiment, the bearing plate 5 is shown in a twisted configuration during installation within the retaining assembly 5.

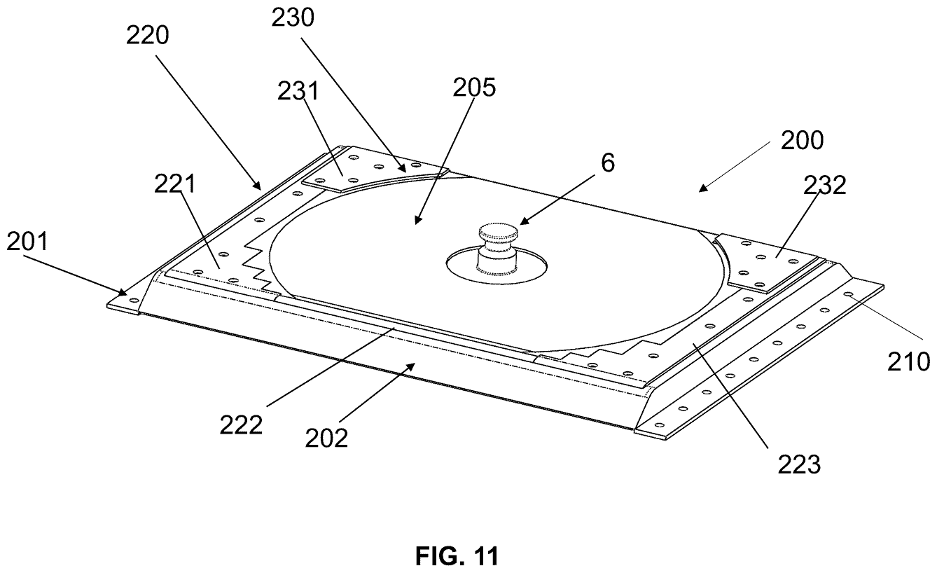

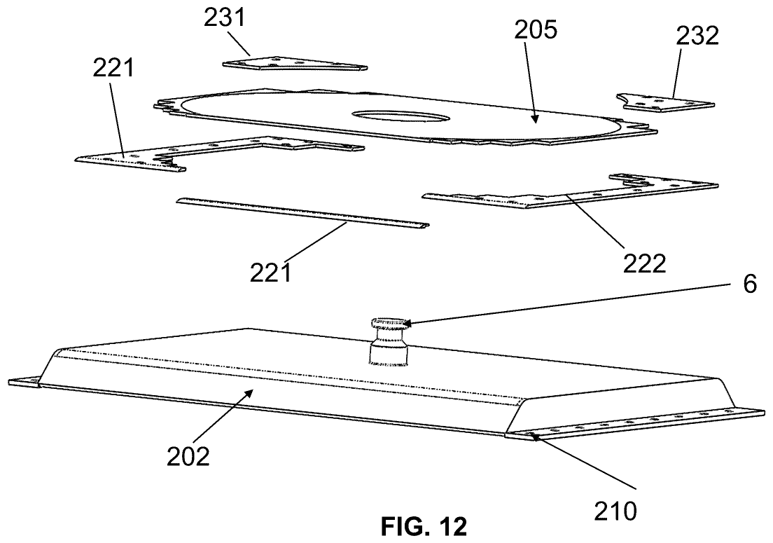

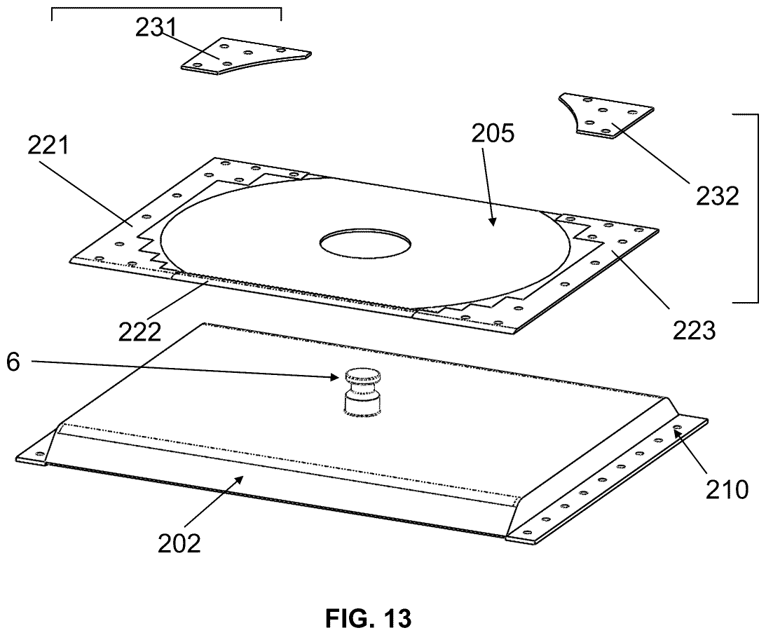

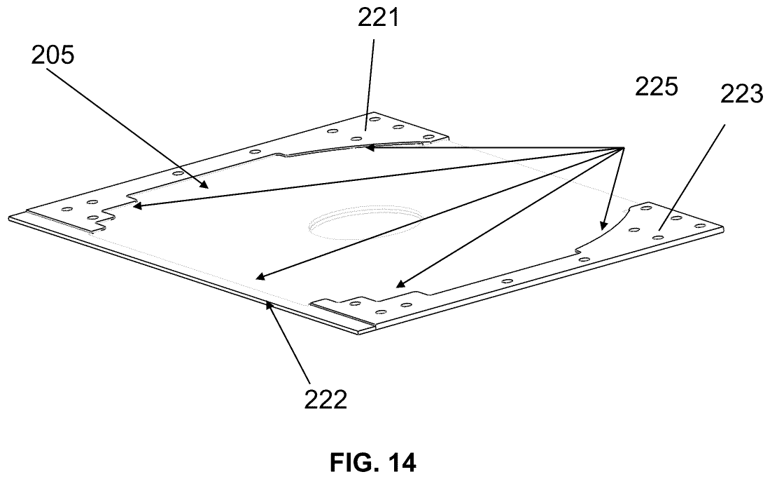

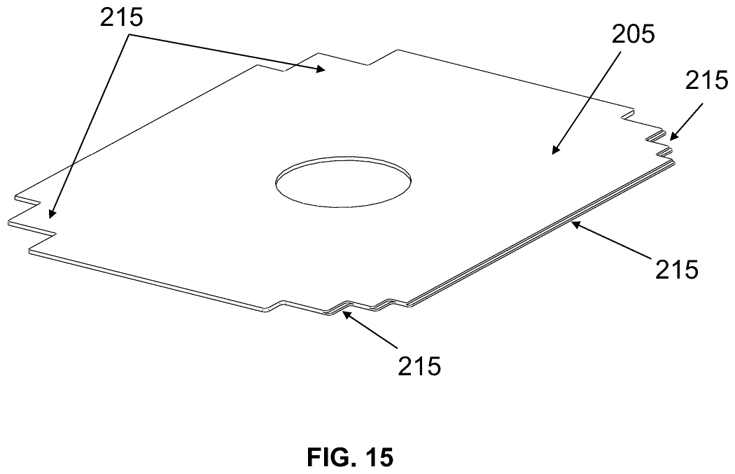

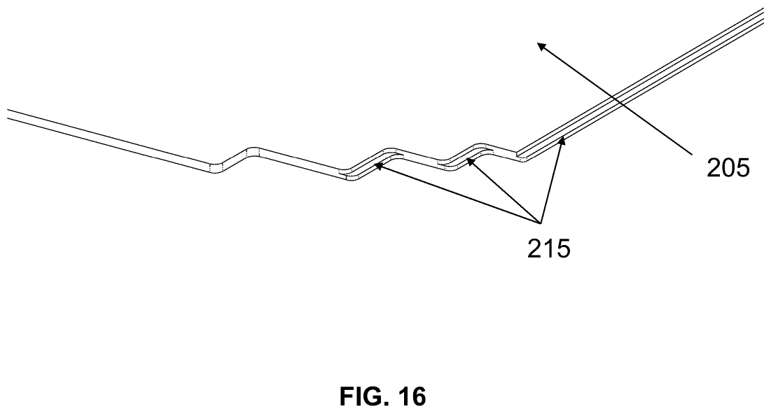

Referring to FIGS. 11-16, a second embodiment of a low-friction docking interface for tanker-type trailers 200 is illustrated. In such embodiment, the low-friction docking interface 200 comprise a rigid main kingpin support plate mounted to the underside 1 of the trailer 7. The docking interface 200 is generally intended to be removable and replaceable.

In the illustrated embodiment, the low-friction docking interface 200 comprises a support plate 201, a docking ramp 202, a bearing surface 205 surrounding a kingpin 6, a locking assembly 220 and a clamping system 230. In the illustrated embodiment, the locking assembly comprises comprise left locking plate 221, right locking plate 2223 and center locking plate 222. The clamping system 230 may comprise a plurality of clamps, such as the clamps 231 and 232.

The support plate 201 is typically exposed to high degree of wear and tear, particularly when trailers are backed against immovable objects or buildings. As a wear element, the support plate 201 may be damaged when docking and/or through operational rotation. The docking may comprise the trailer physically being trapped and unmovable against the building. Also, since the fifth wheel drags along its steel-to-steel surface of fifth wheel to kingpin plate before docking, such area also typically wears out over time. This is especially prevalent on two tracks left and right approaching the kingpin.

In such embodiment, the main support plate 201 may be bolted to the underside of the trailer 7, as exemplify at FIG. 1. The support plate 201 may further comprise a king pin docking post 6 or may surround the kingpin 6 of the trailer. The docking interface may further comprise a plurality of apertures 210 to attach the support plate 201 to the trailer 7. Understandably, any other known methods to attach the support plate 201 to the trailer may be used within the scope of the present invention.

The bearing 205 interfaces with the kingpin 6, while the retention system includes a series of plates 220 and clamps 230 that secure the bearing 205 to the support plate 201. The retaining assembly 220 generally surrounds a peripheral section of the bearing plate 205 and locks the bearing into place. The retaining assembly 220 may be attached to the support plate 201 using any fastener. The clamp system 230 generally overlaps over the bearing surface 205 and the retaining assembly 220 to ensure that the bearing 205 remains solidly in place.

The bearing plate 205 comprises grooves or edges 215 adapted to mate with matching edges or grooves 225 of the retaining assembly 220. As such, the bearing 205 remains flat on the support plate 201 while in use.

The docking ramp 202 ensures smooth engagement between the fifth wheel and the bearing surface 205.

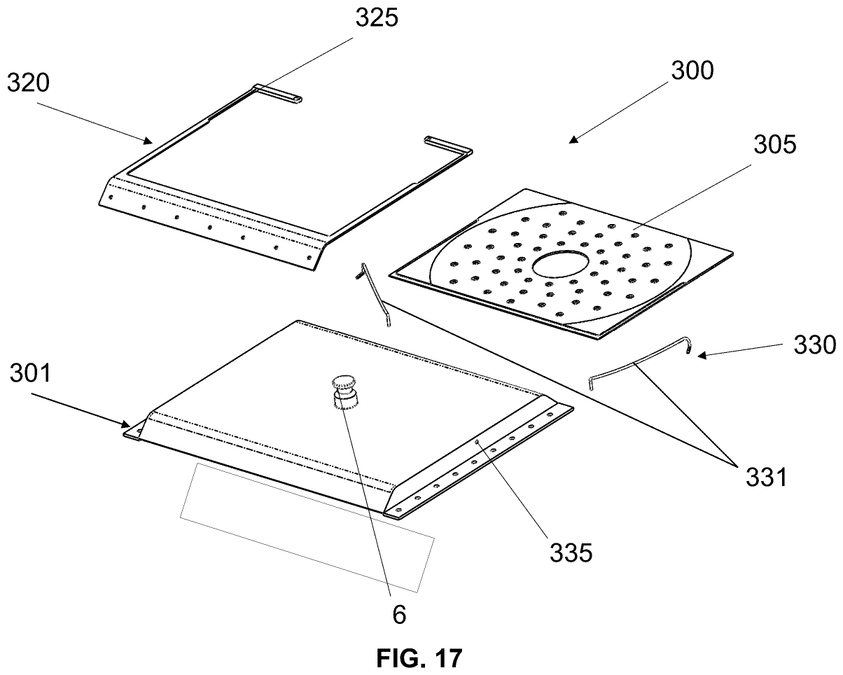

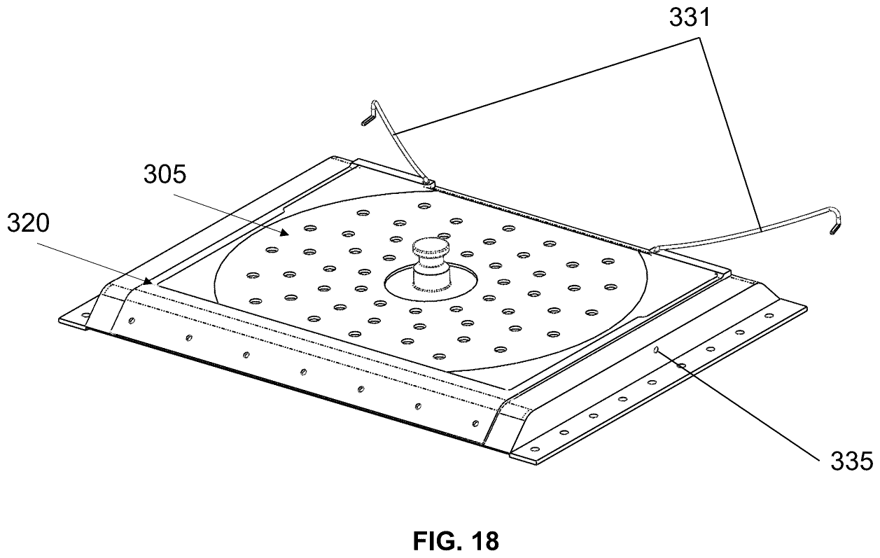

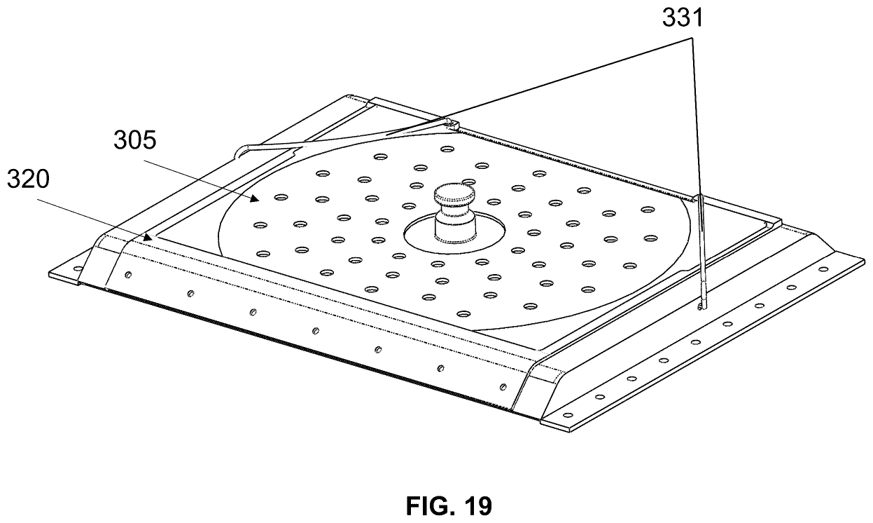

Referring to FIG. 17-19, a third embodiment of a low-friction docking interface 300 is illustrated. In this embodiment, the interface 300 includes a bearing surface 305 surrounding a kingpin 6, a main support plate 301 attachable to an underside portion of the trailer, a locking assembly 320 and a clamping system 330. In such embodiment, the locking assembly 320 comprises edges or grooves 325 adapted to surround and retain the bearing surface 305 which comprise matin peripheral sides. The clamping system 330 comprises at least two pivotable arms 321. The pivotable arm 321 may be spring loaded to provide a force against the bearing surface 305. To secure the assembly, the bearing surface 305 is positioned within the locking assembly 320, such as by bending the bearing surface 305 within the locking assembly 320, and clamped using the arms 321. The arms 321, which are in an open position as shown in FIG. 18, may be rotated into a locked position, as shown in FIG. 19. The arms 321 are secured by inserting one end in holes 335 of the main support plate 301. In such embodiment, the holes 335 are located on the sides of the main support plate 301 but may be positioned anywhere allowing clamping and leaving the bearing surface free for rotation of the docking interface.

In other embodiments, a tool may be used to apply non-symmetrical force to opposite corners of the segmented bearing 5, slightly warping it into a shallow spiral (as seen at FIG. 7). The deformation allows the rear edge of each bearing segment to clear the protuberance or lip 32 of the retaining assembly 3 before snapping into an operational, flat configuration. This twist-insertion method avoids the need for tools or adhesives and allows for easy repositioning when wear is detected. Understandably, any other method for installing or removing the bearing sheet 5 of the retaining assembly 3 may be used within the scope of the present invention.

In other embodiments the bearing plate 5 may be sandwiched between two rigid steel plates that extend radially beyond the bearing's perimeter. Such configuration generally aims at protecting the top surface of the low-friction sheet 5 during docking and prevents it from being peeled or torn off by the fifth wheel during engagement. The bearing surface 5 is thereby constrained without exposed fasteners, though disassembly does require removal of the clamping structure.

. In other embodiments, the bearing surface 5 may be a fixed sheet held in place by a series of locks instead of locking plates.

In yet another embodiment, the bearing surface 5 of the low friction kingpin docking interface 100 or 200 may comprise be fixed using a single deflection plate deflection plate. The deflection plate may be curved. Such embodiment generally aims at minimizing the quantity of material used.

In a further embodiment, the bearing surface 5 of the low friction kingpin docking interface 100 or 200 may be held in place by fixing it with screws on the left and right sides.

In a further embodiment, the bearing surface 5 of the low friction kingpin docking interface 100 or 200 may fully captured on all sides, thus reducing the number of screws needed on each side. Yet a further embodiment of the low friction kingpin docking interface 100 or 200, hot glue may be used as a means to fix the low-friction sheet 5.

A method for reducing rotational friction between a tractor and a trailer is further disclosed. The method generally comprises of disposing a low-friction bearing structure on the underside portion of the trailer 7 surrounding the kingpin 6 of the trailer 7. The bearing structure being adapted to be sandwiched or squeezed between the metal plate of the trailer and the docking system of the tractor vehicle to reduce friction with turning or otherwise pivoting the trailer in relation to the docking system of the tractor vehicle. The method may further comprise constraining the bearing structure from any movement.

In yet another embodiment, the plastic bearing 5 may be held in place using knob type fasteners outside the rotation zone of the bearing 5.

In a further embodiment, the plastic bearing 5 may be held in place using spring type fasteners outside the rotation zone of the bearing and typically towards the rear 180 degrees of the trailer (rear bumper side) since this area has minimal restrictions with interference during docking and turning. An example of the spring type fastener is illustrated at FIGS. 17-19.

In yet another embodiment, the docking interface 100 may be held in place using a disposable plastic bearing 5 with integrated moulded stainless steel impact skid plate to simplify installation of the bearing specifically for tanker type systems

In a further embodiment, the plastic bearing 5 may be held in place using an adhesive, such as but not limited to hot glue.

In some embodiments, the plastic bearing 5 may be held in place using a “pizza style” bearing having a lower upper section and an upper friction area, the lower upper section having a coefficient of friction lower than the upper friction area. The pizza style bearing may be integrated into the skid plate during fabrication.

A method of installing a bearing plate 5 to retaining assembly is also disclosed. The method comprises resiliently inserting the bearing plate 5 under a portion of a retaining assembly to hold the bearing plate 5 in place. The method may further comprise resiliently and simultaneously inserting a plurality of segments of the bearing plate 5 under the retaining assembly and pivoting the bearing plate 5 at the same time. The method may further comprise deforming or twisting a flap 56 or trap points to simultaneously insert the same under protuberances of the retaining assembly to lock the bearing plate 5 in place. The method may further comprise pivoting the bearing plate 5 while deforming or twisting the flap 56.

The method may further comprise using a tool to simultaneously insert the segments of the bearing plate 5 and pivoting the said bearing plate 5 to lock the same to the retaining assembly.

A method to extend the life of a bearing plate 5 is also disclosed. The method may comprise indexing the bearing structure 5 to a new rotational position to redistribute wear, thereby extending the functional life of the interface. The method is applicable both to new trailer builds and to retrofitting existing trailers using bolt-on components, allowing for quick, tool-free replacement even by non-specialist operators.

A method to remove the bearing plate 5 from the retaining assembly 3 is also disclosed. The method comprises resiliently and simultaneously releasing the segments of the bearing plate 5 to release the same from the retaining assembly 3. The method may further comprise pulling the flap 56 or each of the segments while pivoting the bearing plate to release and unlock the bearing plate 5. This method may be used to perform the above method to extend the life of a bearing plate 5.

In a further embodiment, a tool (not shown) may be used to insert or remove the bearing 5 of the retention ring. The tool generally rotates the bearing 5 in one direction, such as counter clockwise and to rotate the bearing in an opposite direction, such as clockwise direction. for both insertion and removal of the bearing. The tool shall allow simultaneously lifting and thrusting the bearing plate 5. Such tool shall allow the positioning of the tool and the execution of the installation or removal within a minute or two by those unskilled in the process with minimal training.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A low friction kingpin docking interface for a tractor-trailer transport vehicle, comprising:
a low friction bearing structure shaped to surround a kingpin of a trailer reducing friction between a trailer and a docking system of a tractor; and
a retaining assembly attachable to an underside portion of a trailer for detachably mounting the low-friction bearing structure to the trailer.

2) The docking interface of claim 1, the bearing structure comprising a plurality of segments, each segment being lockable with the retaining assembly.

3) The docking interface of claim 2, the bearing structure being mountable to the retaining assembly by being pivoted while each of the segments are locked to the retaining assembly.

4) The docking interface of claim 3, each segment comprising a resilient tab comprising a portion lockable with the retaining assembly.

5) The docking interface of claim 4, the retaining assembly comprising a plurality of locking members, each locking member lockingly receiving the lockable portion of the bearing structure.

6) The docking interface of claim 5, the locking members of the retaining assembly being a recess on a bottom surface of the retaining assembly and the lockable portion of the bearing structure being a lip matching with the recess.

7) The interface of claim 1, the bearing structure being made of resilient plastic.

8) The interface of claim 7, the resilient plastic comprising ultra-high molecular weight (UHMW) polyethylene.

9) The docking interface of claim 1, the bearing structure being circular and the retaining assembly being annular and shape to enclose the periphery of the bearing structure.

10) The docking interface of claim 9, the bearing structure comprising a central portion and flaps radially extending from the central portion.

11) The docking interface of claim 10, each of the flaps being separated by a slot.

12) The docking interface of claim 10, the bearing structure comprising apertures for receiving a tool adapted to pivot the bearing structure in relation to the retaining assembly and to simultaneously push or pull the flaps to or of the retaining assembly.

13) The docking interface of claim 9, the retaining assembly comprising a plurality of arc segments joined to form a continuous annular ring.

14) The docking interface of claim 1, the retaining assembly being attachable to a tanker type trailer.

15) A low friction bearing structure to reduce friction of an attachment between a tractor and a trailer transport vehicle shaped to surround a kingpin of the trailer to reducing friction between a trailer and a docking system of a tractor, the low friction bearing structure being attachable yet detachable to a retaining assembly attached to an underside portion of a trailer, the bearing structure being made of rigid yet resilient material.

16) The bearing structure of claim 15, the bearing structure comprising a plurality of segments, each segment comprising a resilient tab comprising a portion lockable to a retaining assembly.

17) The interface of claim 15, the bearing structure being made of ultra-high molecular weight (UHMW) polyethylene.

18) The docking interface of claim 15, the bearing structure being circular.

19) The docking interface of claim 18, the bearing structure comprising a central portion and flaps radially extending from the central portion.

20) A method to remove a low-friction bearing plate from a retaining assembly comprising:
resiliently and simultaneously releasing segments of the bearing plate to release the same from the retaining assembly; and
pivoting the bearing plate to release and unlock the bearing plate.

21) The method of claim 20 further comprising once pivoted, locking the bearing plate to the retaining assembly to evenly wear the bearing plate.

22) The method of claim 21 further comprising using a tool to unlock and pivot the segments of the bearing plate.
